(19) United States
(12) Patent Application Publication
(10) Pub. No.: US 2025/0257705 A1
(43) Pub. Date: Aug. 14, 2025

(54) FUEL FILTER APPARATUS AND METHOD THEREOF

(71) Applicant: DCLIMATE INC., Maryland Heights, MO (US)

(72) Inventors: Robert LATTIN, Maryland Heights, MO (US); Sesha MADIREDDi, Maryland Heights, MO (US); Bruce HUDSON, Maryland Heights, MO (US)

(21) Appl. No.: 18/857,075

(22) PCT Filed: Apr. 17, 2023
(86) PCT No.: PCT/US2023/018878

§ 371 Date: Oct. 15, 2024

Related U.S. Application Data
(60) Provisional application No. 63/331,449, filed on Apr. 15, 2022.

(51) Int. Cl. F02M 37/34; F02M 37/30; F02M 37/44; F02M 37/50

(52) U.S. Cl. CPC F02M 37/34; F02M 37/30; F02M 37/44; F02M 37/50

(57) ABSTRACT

A fuel filter apparatus for use within a liquid fuel in a fuel tank. The fuel filter apparatus can have an inlet screen that is generally long and slender, and a fuel pickup tube is attached to this fuel inlet screen and sealed so as not to leak. The fuel pickup tube is a one-piece tube that conveys clean fuel from a fuel source to a fuel pump. The fuel screen and pickup tube are oriented so that the long axis of the long slender screen is mounted vertical or at least oriented such that one end of the filter is located higher than the diameter of the filter with respect to gravity and located so that the end of the filter assembly stops against the bottom of the fuel tank to ensure positive indication of positioning.

### CROSS REFERENCE TO RELATED APPLICATIONS

This application claims priority to U.S. Provisional Patent Application No. 63/331,449 filed 15 Apr. 2022, to the above named inventors, and is herein incorporated by reference in its entirety.

### FIELD OF THE INVENTION

The present disclosure relates to an improved fuel filter apparatus. In one aspect, the present disclosure relates to a diesel fuel filter having a structure configured to operate in the harsh conditions of on-road trucks in both hot and cold weather activities.

### BACKGROUND

The use of filtration products has a long extensive and varied application with the objective of filtration devices to be able to separate solid particles from fluids. Filter devices for liquid fuel are a common category of filtration devices where solid particles are excluded from fuel before entering a combustion device. Commonly used fuel filters may be located within a fuel system at various points of a fuel system with various advantages/disadvantages. For instance, one common type and location of a fuel filter is a disposable filter that is located between the fuel pump and the fuel metering/distribution device that provides fuel to the end use. This has proven to be a good location where low fuel pump inlet restriction is preferred as there is no filtration device at the inlet of the fuel pump. The disadvantage of this location is that the fuel pump is not protected from harmful particulate and contamination from the fuel system and the replaceable filter has a limited size and limited contaminant holding capacity and must be periodically replaced requiring maintenance intervention.

When fuel filter is located prior to the fuel pump, the fuel pump may be protected from harm although there is a higher flow resistance on the inlet side of the pump which can impede the fuel pump's ability to pump fuel and ultimately affect maximum fuel flow. Since flow resistance increases as the fuel filter accumulates particulates, deleterious flow effects are exacerbated as the filter accumulates contaminants until filter cleaning or filter replacement is required. When the fuel filter is located closer to the source of fuel and further from the fuel pump on the suction side of the fuel pump, the arrangement can develop a lower pressure within the suction of the tube than ambient atmospheric pressure. Therefore, any connection point can offer an opportunity for a small leak in the suction line. This situation can cause air to enter the suction pipe. Air displaces fuel in the suction pipe and will prevent the proper flow of fuel to the rest of system. Air in a fuel system will also cause the fuel pump to not function as designed.

To further complicate the requirements of a fuel filter as specifically related to diesel fuel in the cold weather of wintertime, diesel fuel begins a phase change where components within the fuel solidify as crystals. As the fuel freezes, waxy crystals form in the fuel which are solid particles suspended in liquid unfrozen fuel. Typical filtration methods effectively separate the wax fuel crystals from the liquid fuel, however, in doing so can result in plugging the filter element which in turn starves application of fuel.

Additives can be provided to a diesel fuel tank to suppress the formation of wax crystals during low temperature operation. This method adds operational cost and maintenance intervention and does not fully eliminate the formation of wax crystals. When the wax crystals do form, they tend to be of higher density than the surrounding liquid fuel and when they precipitate in the fuel, they settle down to the bottom of the fuel tank where they can accumulate up to 10% of the total level of fuel in the fuel tank when given sufficient time to settle and accumulate.

Normal fuel systems preferentially withdraw fuel from the bottom or very low in the fuel reservoir tank so the fuel system can provide fuel to the application when the tank is low. In the case of wax crystal formation in the winter, the crystals settle, accumulate and concentrate at the very location of the fuel pick up tubes. Therefore, the ideal location for the fuel pick-up tube will deliver solid particulate laden fuel to the fuel filtration system in the wintertime which can cause fuel filter to plug with waxy crystals and result in starvation of the application or fuel consuming entity.

While harmful solid particulates are effectively captured and separated by current filtration, water is another undesirable common contaminant in fuel. Special filter designs have been developed to strip liquid water from suspension in the fuel. However, many designs of replaceable fuel filters are comprised of a mesh fuel filter located within its own filter housing. In this arrangement, water soon accumulates in the housing and needs to be drained or the filter replaced, or the water stripping capability of the filter media will be lost. This style of filter therefore requires frequent maintenance intervention.

Typical fuel pick up tubes are located as close to the bottom of the fuel tank so that they can withdraw the maximum amount of fuel from the tank. While this does allow the fuel system to withdraw fuel from the bottom of the fuel tank, it also places the main entrance of the fuel system in the very location that fuel contaminants tend to settle, accumulate and reside including water, metallic oxides, sand, grit, dirt, water, biological algae sludge.

Though individual conditions of fuel system can be addressed by conventional arrangement of the fuel system and or methods of filtration, no currently available system and arrangement exists to simultaneously address all the required needs and ensure liquid fuel substantially free of contaminants passes by the fuel pump and reaches the intended fuel metering device for combustion.

Therefore, there exists a need for a fuel filter apparatus that protects the fuel pump from various forms of contamination, has low maintenance requirements, no plugging in the winter-time, provides low pressure drop to the suction side of the fuel pump, provides low chance of air leakage on the suction side, filter housing capacity doesn't limit water stripping capability.

### BRIEF SUMMARY OF THE INVENTION

In one aspect, the present disclosure relates to a fuel filter apparatus. A fuel filter apparatus of the present disclosure can include a filter element assembly that can have a first end and a second. The filter element assembly can include a filter element having an interior surface and an exterior surface and an interior passage runs through the length of the filter element. Fuel can pass through the filter element from the exterior surface through interior surface and into the interior passage of the fuel element. The filter element holder can have an interior portion configured to house the filter element. A fuel tube having a first end and a second end can run through the passage of the filter element to the bottom end of the fuel filter apparatus. A fuel line holder having a first end and a second end can be removably coupled to the filter element assembly and also coupled to the fuel line. The fuel tube can be communicatively coupled to the interior passage of the filter element and pick up clean filtered fuel as it passes through the filter.

In another aspect, the present disclosure relates to an arrangement of components that work together in a system to separate and exclude contamination dispersed within a liquid fuel in a fuel tank and allow the contaminant free fuel to be supplied to a fuel consuming entity. A fuel filter apparatus of the present disclosure can include fuel inlet screen that can be generally long and slender, a fuel pickup tube that can be attached to a fuel inlet screen and sealed so that no leakage is possible and the relative position of the actual fuel pickup tube opening can be located at a controlled position within the fuel inlet screen. A fuel pickup tube can be a one-piece tube that conveys clean fuel from a fuel source to a fuel pump. The fuel screen and pickup tube can be located within the tank holding fuel and oriented so that the long axis of the long slender screen is mounted vertical or at least oriented such that a first end of the filter is located higher than the diameter of the filter with respect to gravity and located so that the end of the filter assembly stops against the bottom of the fuel tank to ensure positive indication of positioning. In some exemplary embodiments where the fuel pickup tube can be flexible, rigid, or semi flexible guide may help locate and orient the fuel pick-up tube within the fuel reservoir or tank.

The invention has improved performance over existing devices such that the invention preferentially allows liquid fuel to pass while excluding harmful particles or contaminants from entering the fuel system including the fuel pump, is easy to install in an accurate and repeatable position, performs its function in a non-invasive manner and requires no regular intervention to maintain.

### BRIEF DESCRIPTION OF THE DRAWINGS

FIG. 1A is an illustration of a fuel tank utilizing an exemplary embodiment of a fuel filter apparatus of the present disclosure.

FIG. 1B is an illustration of a cross-section view along axis A-A of a fuel tank utilizing an exemplary embodiment of a fuel filter apparatus of the present disclosure.

FIG. 2A is an illustration of an exemplary embodiment of a fuel filter apparatus of the present disclosure.

FIG. 2B is a cross-sectional illustration along axis B-B of FIG. 1A.

FIG. 2C is an enlarged view of section A of FIG. 2A.

FIG. 2D is an enlarged view of section C of FIG. 2B.

FIG. 2F is an enlarged view of section D of FIG. 2B.

FIG. 3A is an illustration of an exploded view of an exemplary embodiment of a fuel filter of the present disclosure.

FIG. 3B is a cross-sectional illustration along axis A-A of FIG. 2A.

FIG. 4A is an illustration of a perspective view of an exemplary embodiment of a fuel line holder of the present disclosure.

FIG. 4B is an illustration of a bottom view of an exemplary embodiment of a fuel line holder of the present disclosure.

FIG. 4C is an illustration of a top view of an exemplary embodiment of a fuel line holder of the present disclosure.

FIG. 4D is an illustration of a side view of an exemplary embodiment of a fuel line holder of the present disclosure.

FIG. 5 is an illustration of a perspective view of an exemplary embodiment of a filter screen of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

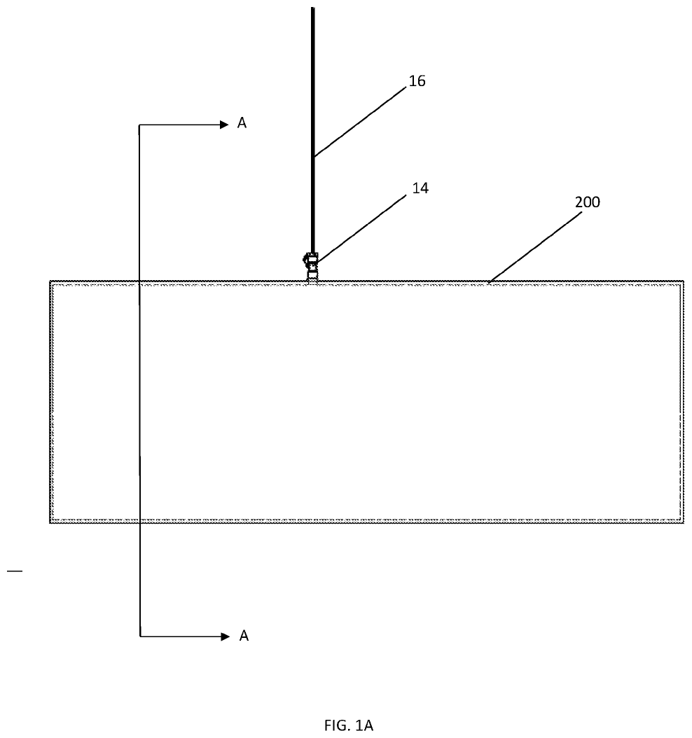

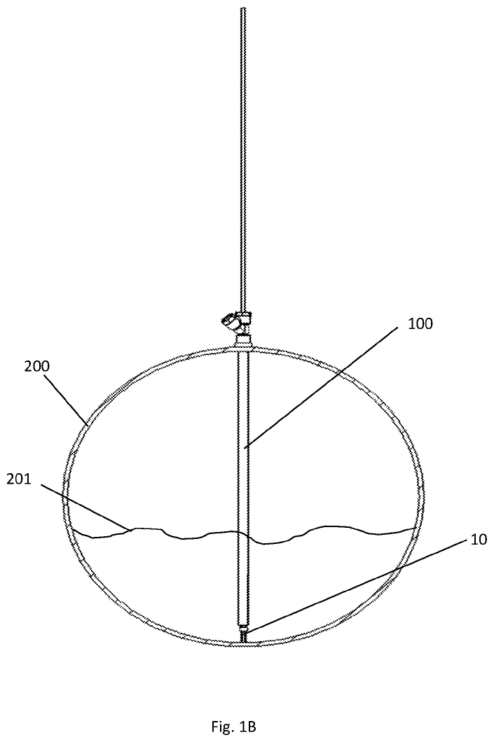

In some exemplary embodiments, the fuel filter apparatus 100 of the present disclosure can be incorporated as part of a fuel system. The fuel filter apparatus of the present disclosure can be used for a diesel fired fuel heater where fuel is withdrawn from a main chassis mounted fuel tank on a truck. As shown in FIGS. 1A-B, the fuel filter apparatus 100 can be coupled to a fuel tank 200 to allow for any fuel being removed from the tank 200 to be adequately filtered so as to prevent any downstream contamination from entering the combustion chamber or other apparatus.

The filter apparatus 100 can have a connection component 14 that can allow for easy removable connection between the apparatus 100 and the tank 200. A fuel tube/line 16 can then communicatively couple the fuel tank to an apparatus needing the clean filter fuel. An interior portion of the filter apparatus 100 of the present disclosure can extend into a tank of fuel cell 200 generally perpendicular to the fuel contents 201 of the tank 200. A bottom stopper/fuel line holder 10 of the filter apparatus 100 can contact the bottom of the tank or be in proximity to the bottom of the tank 200 to ensure that the filter apparatus is able to remove all or nearly all of the fuel from the tank when in operation.

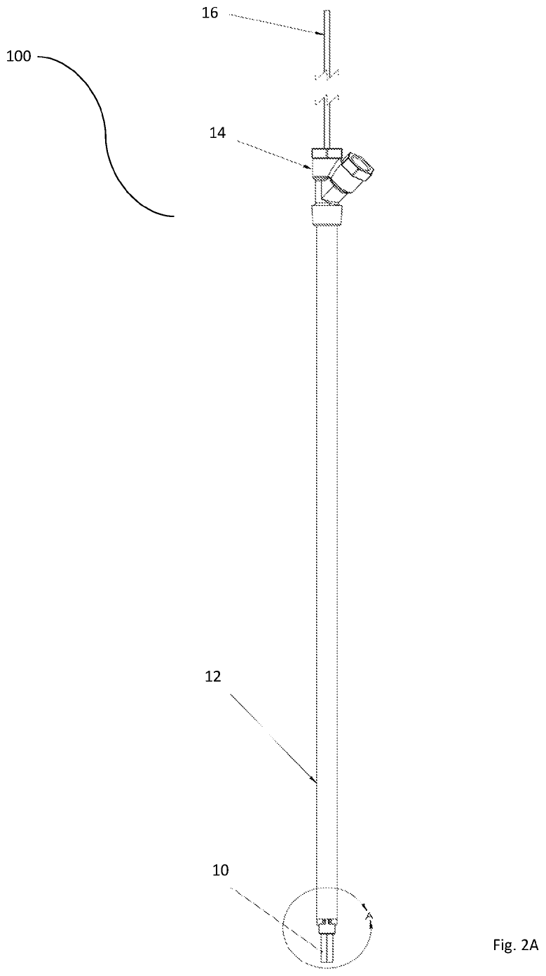

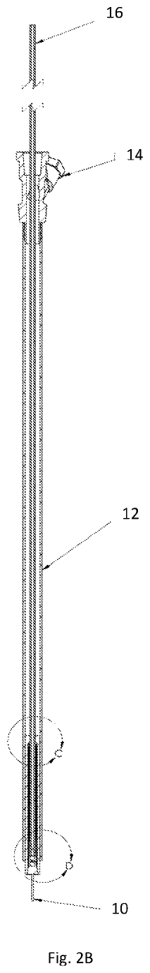

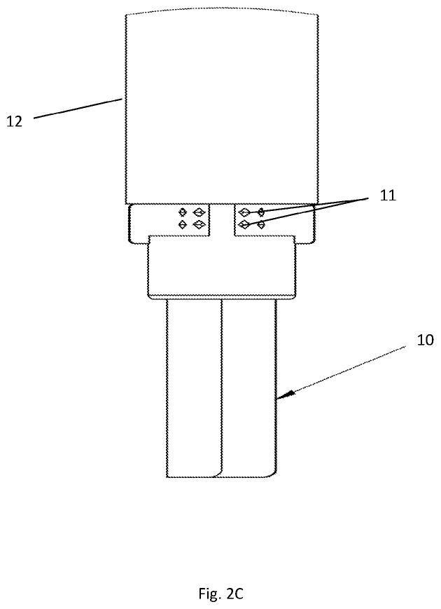

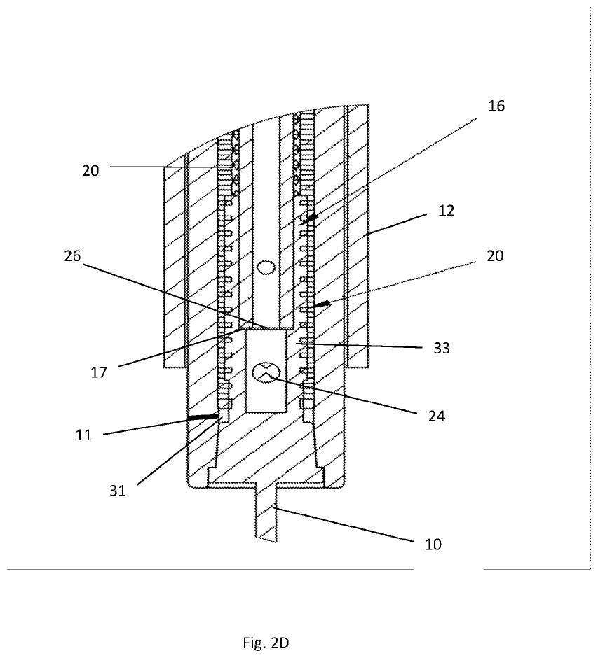

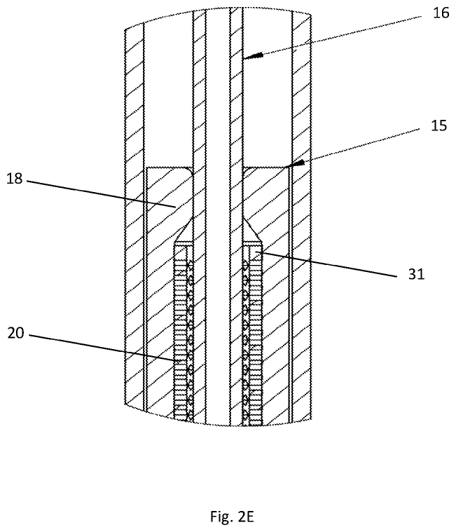

As shown in FIGS. 2A-E, a fuel filter apparatus 100 of the present disclosure can include a fuel line holder 10, a filter assembly guide tube 12, a connection component 14, and a fuel tube 16 as shown in FIGS. 1-2. As shown in FIG. 1C, the fuel line holder 10 can have one or more apertures to allow for the entry of fuel into a filter assembly 15 of the filter apparatus 100 of the present disclosure. The fuel tube 16 can extend through the interior of the fuel guide tube 12 and can be supported by the connection component, the filter assembly 15, as well as the guide tube 12 to provide for greater rigidity. The fuel tube 16 can be removably coupled to the fuel line holder 10 at the second end of the filter apparatus 100.

The fuel tube 16 can have one or more apertures that can be fluidly connected to the interior side 33 or the filter element 15. The apertures 11 can be fluidly connected to the reservoir 200 and allow fuel to enter the filter assembly 15 and contact the exterior surface of the filter element 20 Fuel that has been filtered within the interior cavity 33 of the fuel filter can then be pumped from the filter assembly 15 to an application, such as an engine or other apparatus that requires clean fuel. In some exemplary embodiments, the filter element 20 can be ribbed and/or have ridges that can create additional surface area for filtering as well as area for fuel to first come into contact with the exterior surface of the filter element 20 within the filter assembly 15. In some exemplary embodiments, the filter element 20 can be a filter screen, mesh, or any other suitable material.

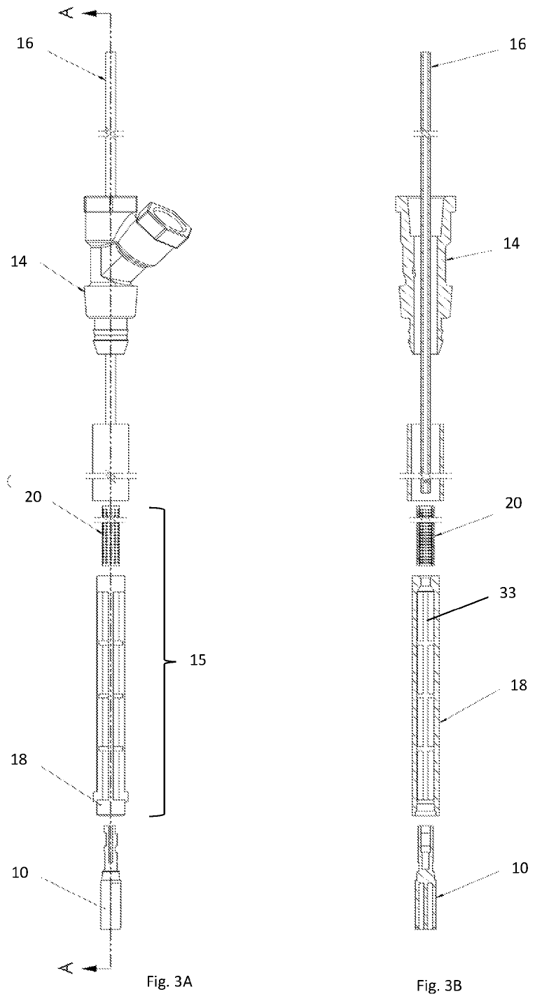

As shown in FIGS. 3A-B, fuel can be withdrawn from a fuel tank first passing through a filter assembly 15, can include a filter screen holder 18 and a filter element 20. In some exemplary embodiments, the filter screen holder can be injected molded around the filter screen 20. When fuel passes through the filter screen 20, suspended contaminants within the fuel are separated. The fuel can pass from the dirty/exterior side as it enters the filter assembly and to the clean side/interior side of the filter screen 20. In some exemplary embodiments, the fuel filter assembly 15 can have one or more channels/passages 31 between the filter holder 18 and the filter element 20 to allow fuel to engage the filter element 20 and pass through the filter element into the interior of the filter element 20. Fuel that passes through the filter screen 20 can then be picked up and transported by the conveyance tube 16 to be used by the fuel system.

In some exemplary embodiments, the fuel filter apparatus 100 can include a long and slender filter element 20 that can be fully sealed from the outside to inside on both ends to the media in which it is in contact. On one end of the filter element 20, the filter is completely sealed while on the opposed end, a tubular passage is present to convey filtered fuel to the application but is otherwise sealed with a rigid connection between the fuel conveyance tube 16 and the end of the filter element 20. In some exemplary embodiments, the filter assembly 15 can have a first end and a second end, wherein the first end can allow for the conveyance tube 16 to run generally through the passage towards the second end of the filter assembly 15. The second end of the filter assembly can be configured to removably couple to a fuel line holder/bottom stopper 10.

The fuel line 16 and the bottom stopper 10 at the respective ends can form a seal at each end to prevent clean fuel on the interior side of the filter element 20 from leaking out and similarly from dirty fuel from seeping into the clean side of the filter element 20. At no point in the filter assembly 100, including the fuel conveyance tube 16, is there an opening any larger than the mean pore diameter of the filtration media of the filter element 20. In some exemplary embodiments, an optional filter holder 18 can provide a support structure to improve the filtration element's resistance to physical deformation and or damage before, during and after installation and while in expected service.

Any suitable filter media can be utilized for the filter element 20. In some exemplary embodiments, fuel filter filtration media of woven plain weave between about a 100 to about 400 mesh screen or about a 180 to about a 320 mesh screen. Stainless steel or nylon materials can be utilized the mesh although other media may be employed with suitable effectiveness. It should be noted that the surface of the mesh screen should be developed such that the surface geometry or surface finish does not promote nucleation and diesel fuel crystallization at low temperatures at or near the cloud point of diesel fuel. In some exemplary embodiments, the filter assembly can use face packing as a means of filtration or a single plane of filtration. Other filtration techniques can be utilized, such as a more of a 3D region where contaminants are captured and held within random mesh, stacked or distributed filtration media. The dirt holding capacity of the invention may be therefore controlled by the amount of surface area the filter presents to the contaminated fuel. In some exemplary embodiments, surface area can be understood and defined by a using a cylindrical geometry where the surface area is proportional to the diameter of the cylinder and the length. When constrained by size, more filter surface area can be developed by adding one or more pleats to the filter mesh whereby the number and the depth and length of each pleat increases the filtration area exposed to the fuel proportionally and thereby the dirt or contaminant holding capability.

The fuel filter apparatus 100 of the present disclosure can be installed in a fuel tank 200, and the filter element component 20 can typically be installed so that the major length of the filter axis is vertical or at least oriented such that one end of the filter is above the other end of the filter with respect to gravity. The orientation of the filter component of the invention can be important to its operation for various reasons. When particulates accumulate within the fuel tank 200, they are commonly heavier than the surrounding fuel and settle to the bottom of the fuel tank. The generally vertical orientation allows the bottom or lower region of the filter to be obstructed or partially obstructed with particulate contamination corresponding to the higher probability of finding contaminant within the lower strata of the fuel. Regions of the filter element 20 that are more distant from the bottom of the fuel tank may be predominately unobstructed and allow liquid fuel to pass freely through the filter mesh of the filter element 20. Fuel may pass through the filter at a location higher or further with respect to the bottom of the tank than closer to the bottom of the tank. In use, liquid fuel can be driven through the of the surface of the filter element 20 and contaminants that have a mean diameter larger than that of the filtration mesh will be separated from the fuel. After the fuel has passed through the filtration surface 21, cleaned fuel can travel unobstructed to the inlet 28 of the fuel pick-up tube 16. Additionally, the openings 24 and 26 can allow for fuel to flow from the interior clean fuel side 33 of the filter assembly 15.

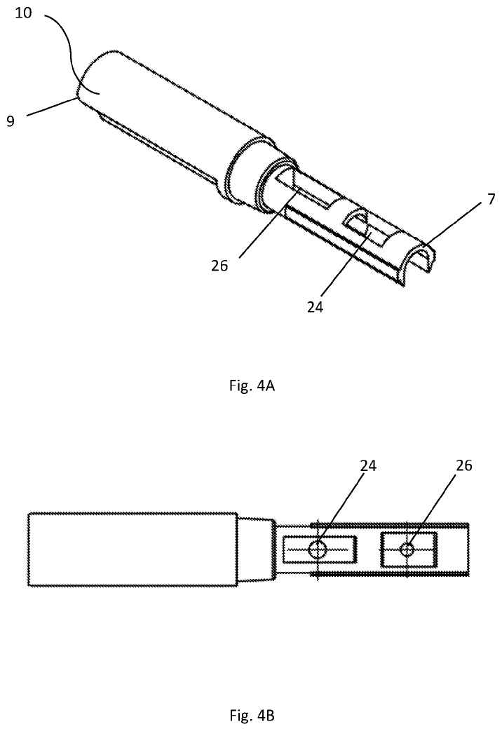

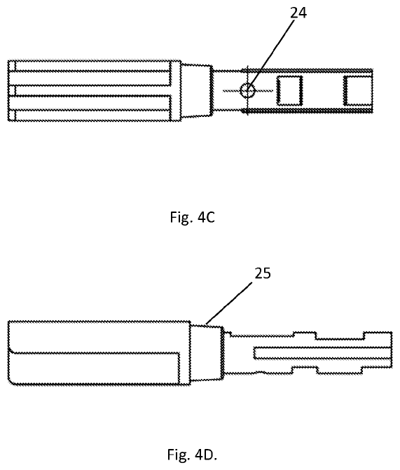

As shown in FIGS. 4A-D, a fuel line holder 10 can be removable coupled to the second end of the filter assembly 15. The second end 17 of the fuel line 12 can be removably coupled and/or rest against a first end 7 of the fuel line holder 10. The second end 9 of the fuel line holder 10 can have one or more ribbed members to all contact the bottom of a fuel tank and can similarly allow to break and prevent sediment from reaching the intake apertures 11 of the filter apparatus 100.

In practice, the fuel filter apparatus 100 can be used for auxiliary loads on a truck will be in operation during times when the main truck engine is off and the truck is not traveling. In this case, contaminants within the fuel tank are more likely to settle to the bottom of the fuel tank 200 and accumulate in the lower extremity of the fuel tank and not kept in suspension by the motion of the truck. As such, a typical fuel filter located within the fuel tank will tend to accumulate contaminants at a greater rate lower on the filter than higher on the filter. The orientation of the fuel filter apparatus 100 of the present disclosure has regions low in the tank and some regions higher in the tank relative to the lowest extreme. Because of the design of the filtration component in the present disclosure described and for embodiments only using face packing as the means of holding contamination, the contamination is not tightly entrapped within a 3D matrix of the filter media and therefore can be dislodged from the surface of the filtration component with mechanical methods.

The fuel line holder 10 can be formed with a two-piece injection mold. The holder 10 can have a tapered portion 25 that can have an interference fit to the filter assembly 15 ensuring a positive seal. Windows 24, 26 can be formed to center and provide a positive stop and location position of the fuel line tube within the filter assembly 15. This can ensure the inlet to the filter assembly is a pre-determined distance from the bottom of a fuel reservoir.

In one exemplary embodiment, a mechanical cleaning method that is provided by the application is that of the fuel sloshing back and forth as the truck travels down the road when the fuel tank. This is particularly prevalent when the fuel level is lower in the tank than when the tank is full. In this case the action of both diesel fuel and tiny entrapped air bubbles can rapidly move past the surface of the filtration component 20 of the invention when the truck is in motion and this action promotes dislodging any collected surface contaminant on the surface of the filter apparatus 100. After the contaminating particles are swept away from the surface of the filter component 20, they will again be suspended in the fuel and may be caught by the main diesel engine fuel filter, taken out during normal fuel tank maintenance procedures or simply retained in the fuel tank without harm to other downstream components. An exemplary embodiment of the fuel filter apparatus of the present disclosure can provide a self-cleaning action and does not require physical maintenance intervention to keep the surface of the filtration element at least partially free from contaminating substances.

Additionally, external features within the fuel tank 200 can be designed to enhance this cleaning action by increasing the velocity of fuel moving past the fuel filter mesh or ensuring that the sloshing action of the fuel is predominantly tangential to the surface of the filter mesh or both. An example of how the sloshing action of the fuel being predominately tangential to the surface of the fuel filter is by using an oval or more flattened filter shape instead of the cylindrical shape previously disclosed. When the filter element is oriented such that the major axis of the flattened cross section is aligned with the major axis of the fuel tank, motion of the sloshing fuel will be predominately tangential to the surface of the fuel filter.

After the surface of the filtration element 20 is wetted with diesel fuel, the surface of the filter element 20 will tend to repel liquid water because of the high surface tension of liquid water and the relative immiscibility of water in diesel fuel. Within appreciable limits as set forth by the surface energy of the fuel filter and pore diameter of the filtration media, liquid water will be resisted from flowing through the filter media while diesel fuel will flow through with only normal hydrodynamic flow loss impedance to flow. Water contamination within a fuel tank can naturally settle to the bottom of the tank and lower density fuel within the tank 200 will float on top of the water. When both zones of water and fuel are in contact with the fuel filter element 20 at the same time and water having an additional pressure requirement of the water to overcome the surface tension of filter mesh composition to water interface, water will be excluded from flowing through while diesel fuel will pass through the filter mesh. This is true even when the fuel pick-up tube 16 within the filter assembly is located such that is lower than the free surface of liquid water within the tank.

While liquid water is effectively excluded from passing through the filtration element 20 of the fuel filter apparatus 100 by use of the surface tension of the water and relative immiscibility of water and diesel fuel, a water/diesel emulsion has different surface tension properties that may be partially excluded by the invention. A water/diesel fuel emulsion can be partially excluded from passing through the filtration element. When water and diesel fuel are mixed into an emulsion, the resulting mixture has a viscosity significantly higher than either water or diesel fuel and the resulting viscosity can be 5 to 50 times higher than diesel fuel at the same temperature. Also, this emulsion can stratify and sit on top of the water since the mixture has a density less than pure water and heavier than diesel fuel.

When water is present in the diesel fuel mixture, the liquid water sits on the bottom of the fuel tank and therefore interfaces with the lowest zone of the filter element, an intermediate zone may be present which is a mixture of water and diesel fuel in the form of an emulsion and a high zone where the diesel fuel predominates. The rate of water separation can be calculated by assuming 3 separate zones of interaction where the filter element acts. In the lowest zone, there must be a sufficient pressure differential for liquid water to overcome the water surface tension and pass through the filter mesh and enter the region of clean fuel.

Absent adequate pressure differential, no water will pass the filtration element. In the middle zone, some of the emulsion can pass through the filter mesh although the rate is significantly reduced compared to clean fuel since the viscosity of the emulsion is significantly greater than that of the diesel fuel. In the top zone, diesel fuel can flow through the filter mesh with relatively low flow resistance through the mesh. In most cases, pressure differential across the mesh is uniform between the volume of fuel outside the fuel filter in direct communication with the contents of the fuel tank and the inside of the fuel filter. Inside the fuel filter is defined by fuel that passes through the fuel filter mesh and is part of a fuel volume that is in direct communication with the fuel filter outlet tube.

Fuel flow (or total fluid flow) through the filter is a function of pressure differential across the filter mesh or more specifically, differential between the inside and outside of the fuel filter element 20, the viscosity of the fuel or fluid in contact with the outside surface 21 of the fuel filter and, any additional forces that require a pressure differential to overcome such as liquid surface tension and, the physical geometry of the filter mesh composition. For the sake of this disclosure, fuel can flow from the outside of the filter element to the inside of the filter, however, the basic function and operation is the same independent of fuel flow direction.

When the required fuel velocity flow rate through the filter mesh is low (the actual flow rate can be calculated by the surface area divided by the fuel volume flow) the pressure differential across the filter mesh can also be low, and therefore, the driving force for water to flowthrough the filter mesh is consequently low. Although some water can pass through the invention described, when the mesh size and properties are chosen correctly, the invention excludes most water and combustion devices can typically tolerate a little water.

Since the surface area of the zone of emulsified water fuel mixture exposed to the filter component is low and the viscosity is high, the amount of actual water/fuel mixture that passes through the filtration component of the invention is relatively small compared to the fuel without water contamination. The fuel filter apparatus of the present disclosure can strip water from the surrounding fuel. The stripped water is not held within an independent and exclusive chamber associated with the filter assembly 15 but is retained within the fuel tank 200. For this reason, the practical limit of how much water can be stripped by this invention is much higher than other commonly existing devices.

Placing the fuel filter apparatus 100 on the inlet of a pickup tube 16 can be a concern as fuel pumps typically have a suction limit which they can achieve. Therefore, increased flow resistance on the inlet side of a pump can limit the pump's ability to achieve the proper height of draw and ultimately increased inlet suction resistance may reduce available flow to the combustion device. In an optimally configured embodiment of the invention, a fuel pump can be placed immediately after or downstream of the fuel tank or reservoir and kept as close to the free surface of fuel within the reservoir as possible to reduce the height the pump must lift the fuel. This location limits the negative pressure difference requirement on the inlet of the fuel pump and improves system performance.

In cold weather, an exemplary embodiment of the fuel filter apparatus 100 of the present disclosure can reduce common fuel system problems that can result from fuel being cooled to the cloud point, causing the formation of small crystals within the liquid fuel. These crystals precipitate from the liquid fuel and since they have a higher density than the surrounding fuel, they will begin to settle. Depending on the diesel fuel mixture of Diesel 2 to Diesel 1 and any other additives in the fuel, the amount of precipitation fuel crystals can be about 10% of the total depth of the fuel within the fuel reservoir. For fuel filters that are exclusively retained on the bottom of the fuel reservoir, the filter can be obstructed by fuel crystal precipitate. Since the invention described is long and slender and oriented vertically, at least some of the filter is generally located above the strata of precipitated fuel within the reservoir as shown in FIG. 1A-B. Liquid fuel will form a low flow resistance path from above the precipitate strata within the reservoir, through the interior of the filter assembly 15 of the invention to the inlet of the fuel pickup tube 16. Therefore, liquid fuel is supplied to the fuel consuming application without causing an undue flow restriction and consequent fuel interruption to the inlet of the fuel pump.

Water can be a common contaminant that should be expected to enter a typical diesel fuel system reservoir. When any water is present within the fuel reservoir, water is excluded from entering the inside of the filter assembly 15 as described and when it is cold, the water will freeze outside of the fuel filter component. If any fuel is present above the frozen water layer and still within the window of the filtration apertures 11, fuel will find a low resistance path through the filtration media to the entrance of the fuel pick up tube 16.

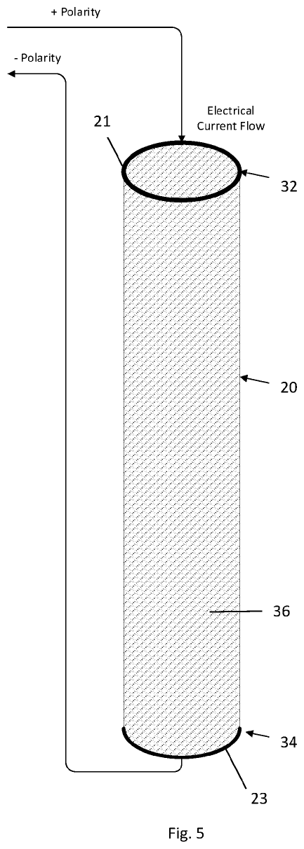

Since the physical properties of fuel may change significantly when the fuel temperature is low, the filter may exclude fuel from passing through the filter and thereby cause stoppage of the fuel as sufficient waxy fuel crystals block the free flow of liquid fuel through the filter mesh. An exemplary embodiment of the present disclosure can utilize an electrically conductive material such as stainless steel to make the filter mesh, the filter can be configured such that electricity is passed through the filter mesh and the filter mesh itself will produce resistive heat and can be used to melt the accumulated fuel wax crystals adhered to the surface of the filter mesh, as shown in FIG. 5. In some exemplary embodiments, the filter element 20 can have a first end 21 and a second end 23. This approach uses a minimum amount of electrical energy, directed at the exact location of fuel crystal accumulation to melt the crystals and thereby allow liquid fuel to pass through the filter unimpeded. In some embodiments, a ring 32,34 with low electrical resistance may be electrically connected to both ends of the mesh filter 36 element and opposing electrical connections be made to both rings so that electrical current may flow between the two rings 32, 34. The amount of electrical energy applied to the filter element 20 may be adjusted so that the minimum amount of energy is applied to the filter element. In some exemplary embodiments, a controller such as the engine management system or onboard vehicle computer can determine the temperatures of the fuel to determine if a current is needed.

For instance, when the fuel temperature is above 32° F., no electrical energy may be applied to the filter element 20 since it is unlikely that wax crystals are present in the fuel. As the fuel temperature decreases below 32° F., progressively more energy may be added to the filter 20 to prevent fuel crystals from accumulating on the exterior side of the fuel filter element 20. The amount of energy applied may also increase or decrease depending on the rate of fuel flow through the filter where more fuel flow requires more electrical energy supplied to the filter element and lower fuel flow requires less flow to the heating element. The amount of energy delivered to the filter may be adjusted by either adjusting the voltage applied to both ends of the filter mesh element or the using a constant voltage and varying the time that the voltage is applied to the mesh such that a variable pulse width of electricity is applied to the filter.

In one exemplary embodiment, the filter element 20 can receive a constant 1.2 volts and 2 amps of electricity across the filter for 2.4 watts of heating. In another exemplary embodiment, the filter element can receive 2 pulses of 12VDC electricity at 20 amps with a duration of 50 milliseconds for every second of operation for the same 2.4 watts of electrical heating. In various fuel systems, an electrical solenoid pump can be provided to pump fuel at a particular flow rate. The pump flow can be controlled by applying a constant voltage and increasing or decreasing the frequency of electricity pulses supplied to the pump whereby more frequent pulses yield more flow through the pump. By using the electrical signal from the pulse type fuel pump (directly or modified) applied to the fuel filter heating element, the amount of heating will be increased or decreased directly proportional to the rate of fuel flow through the filter. Through the concealment of the filter element 20 within the filter holder 18, and within the guide tube 12, any potential safety risk can drastically be reduced.

The fuel filter apparatus can be designed such that the fine mesh of the filter element 20 affords sufficient capillary action as the meniscus of fuel supported by the mesh of the filter element 20 forms an effective seal to air between the outside of the filter component assembly and the inside or filtered part of the filter component. The sealed portion on the inside or clean side of the filter component (with the fuel pickup tube) can therefore support a negative pressure which can be maintained without air passing from the outside of the filter component to the inside of the filter component. As such, the level of liquid fuel outside the fuel filter component can be maintained below the inlet of the fuel pickup tube without the fuel pickup tube drawing air into the fuel pickup tube. This condition can continue even with additional dynamic conditions of fuel being withdrawn through the fuel pickup tube from the inside of the fuel filter component as long as some fuel from the fuel tank is at a level that reaches the window of filter screen mesh where fuel can flow through the filter mesh from the outside to the inside of the filter element 20.

The fuel pickup tube inlet 16 can be physically located with respect to the bottom of the filter component so that the end of the fuel filter inlet cannot be closed off by placing the pick up tube inlet too close to the bottom of the fuel filter component assembly. Additionally, the design of the filter component assembly allows a positive stop so that when the fuel filter component is assembled, the assembler can ensure the fuel pick up tube is inserted adequately into the fuel filter component assembly such that the fuel filter pick up tube is sufficiently low in the long slender filter assembly such that the pick-up tube inlet is near the bottom of the assembly. In this position, the fuel pick-up tube inlet 28 has the greatest chance of contacting liquid fuel and withdrawing fuel from a fuel reservoir even when the system is newly installed and the fuel filter assembly 15 is not fully filled with fuel.

The fuel pickup tube 16 can be physically sealed to and commonly joined to the top of the filter housing 20 such that the filter and pickup tube comprise one final assembly. As such, no holes or leakage paths exist larger than the mean pore diameter of the filter mesh. Because of this construction requirement, no contaminants including: air, water, particulate, algae or other undesirable detritus can enter the inside of the fuel filter assembly 15 where the fuel pick up entrance is located.

In some exemplary embodiments where more fuel filter element 20 surface area is required, the fuel filter screen may have pleats such that the filter has more surface area exposed to the contaminated or potentially fuel. Using pleats increases the fuel to mesh surface area without increasing the overall length of the filter component or effective diameter or cross-sectional area of the filter component. Cervices between the pleats act as mechanical support for a meniscus to form and draw fuel higher in the crevices than the typical free surface of fuel in a fuel reservoir would allow. The formed channels 33 therefore allow low flow resistance path for fuel to flow on the outside of the fuel filter assembly to the inside of the fuel filter assembly when the level of fuel in the reservoir is below the top of the fuel filter component. The channels 33 can run longitudinally along the axis between the filter element 20 and filter holder 18.

Pleats can also be used to add mechanical structural rigidity to the fuel filter component which can improve the system performance when used in harsh conditions of the application. Although, pleats may reduce the internal volume available for clean fuel within the filter component, this volume is not particularly important to proper operation of the fuel system or consuming device.

The fuel filter assembly is designed such that even when the fuel filter is installed within a guide tube 12, passage of fuel to the full area of the filter is unimpeded. In this case, when the fuel filter uses a continuous tube 12 as a mechanical support to locate and constrain the fuel filter component within the fuel reservoir, sufficient clearance exists between the fuel filter assembly 15 and the support tube 12 such that fuel can flow, unimpeded, from the fuel reservoir 200 to the fuel filter element 20. As such, either features are molded into the fuel filter component assembly 15 to prevent blockage of fuel flow from the fuel filter guide or clearance is added to the fuel filter assembly so that in no way can the fuel guide tube block fuel from entering the fuel filter assembly.

The fuel filter apparatus 100 is designed such that when it contacts the bottom of the fuel reservoir 200, the fuel filter mesh is located at desirable location within the fuel reservoir 200. This location typically places the window of fuel filter mesh at a location where it above the dirtiest and most concentrated region of expected contaminant at the bottom of the fuel reservoir but still low enough to withdraw fuel from the fuel tank when the level of fuel is relatively low within the reservoir. The bottom member/fuel line holder 10 can provide a support that maintains the apertures 11 above the bottom of the fuel reservoir 200 to prevent contaminated regions within the reservoir. Although the actual dimension is commonly proportional to the size of the fuel tank and fuel tanks vary greatly in size, in some exemplary embodiments for a tank of approximately 22 inches in diameter, a location considered to be good for the invention described places the lower end of the fuel filter mesh apertures/window 11 at between about 0.5 to 2 inches or about 1 to 1.5 inches from the bottom of the fuel tank reservoir 200.

The guide 12 is commonly of tubular section and may either be rigid or semi rigid. The guide tube 12 can ensure proper orientation of the filter assembly 15 so that the long axis of the assembly is predominately vertical with respect to gravity although the invention will still function if the filter component is not perfectly vertical. The guide tube 12 can also keep the filter assembly 15 and pickup tube 16 constrained and prevents excessive motion of the filter and pickup tube assembly as the truck or mobile equipment moves during its normal activity. Sloshing fuel in the reservoir 200 can exacerbate movement of fuel within the reservoir 200 and by consequence it has the potential to move and damage the fuel filter assembly 15 and/or pickup tube 16 if inadequately constrained. There rate of fuel movement is higher with a correspondingly higher chance of damaging or displacing the fuel filter for the following conditions: when the fuel is low in the reservoir tank, the tank is big with respect to the size of the filter component and there is excessive motion, particularly motion that coincides with the natural frequency of motion of the fuel within the reservoir. The guide tube 12 should be sufficiently sturdy to restrain motion of the filter/pickup tube assembly from motion of sloshing fuel within the reservoir.

The fuel filter guide tube 12 may be designed such that the pickup tube assembly 16 may inserted from the top of the reservoir 200 and pass fully down the length of the guide tube 12 where the fuel filter 20 or bottom member 10 contacts the bottom of the fuel tank reservoir. Alternatively, the fuel filter pickup tube 16 may be inserted at the end of the guide tube 12 with a feature on the fuel filter prevents that prevents the filter assembly from fully sliding into the guide tube 12 and thereby ensures the fuel filter is never retracted into the guide tube during or after assembly. Features may be implemented such that the position of the fuel filter relative to the end of the guide tube is always maintained.

The fuel filter guide tube 12 can support and guide the fuel filter pickup tube assembly to a desired location within the fuel reservoir. In some exemplary embodiments, the construction of the fuel filter guide tube 12 may be a simple extruded semi rigid plastic tube, a rigid metal tube or other structure that constrains and locates the position of the fuel filter component assembly. The fuel pickup tube 16 can be comprised of a flexible or rigid material. For installation on existing equipment, a flexible fuel pickup tube 16 may be preferred as extraneous equipment may prevent direct access for installation with a rigid fuel pick-up. When using a flexible fuel pickup tube, a guide tube 12 can also be used to ensure proper positioning and orientation of the filter component within the fuel reservoir. When a rigid fuel pickup tube 16 is used, a fuel filter guide tube 12 or structure may not be required as the rigid fuel filter pickup tube can serve as the location and support device.

Fuel/water separation aspect of the invention may be enhanced by applying a surface treatment to the filter mesh imbuing the filter mesh with properties that the lower surface energy and lower wettability of the base material. In doing so, the coating thereby creates a hydrophobic or water resisting surface at on the filter mesh. Such a feature is beneficial such that droplets of water suspended within the diesel fuel and have a mean diameter larger than the minimum opening size of the filter mesh will require a larger driving force to move them from the outside of the filter to the inside of the filter than filters without the coating. When the driving force available from pressure differential between the outside of the filter and inside if the filter is sufficiently low, a greater percentage of suspended water droplets will be excluded from passing the filter media. Since the water droplets have no rigid structure, sufficient pressure differential can cause the droplet to change its shape in a manner that it is possible to allow the water droplet to flow through the filter mesh from the outside to the inside. Therefore, practical embodiments of this invention that take this effect into account will be designed to transport sufficient supply of fuel while having low velocity movement of fuel from the outside. The easiest way to achieve this is by adjusting the filtration surface area whereby larger surface areas will require lower flow per unit area of fuel and thereby require a lower pressure difference from the outside of the filter to the inside of the filter.

When considering surface treatment of the filter media to enhance water separation activity, a class of chemicals that promote hydrophobic behavior should be considered. Many of these hydrophobic chemicals are non-polar molecules may be used such that they preferentially repel water molecules while attracting and wetting easily hydrocarbons such as oil or fat molecules. Therefore, for this invention, an ideal coating would be both hydrophobic and oleophilic. Such a surface had other benefits in that they may reduce the activity of trapped particulate to stick to the outer surface of the filter and thereby promote active cleaning of the fuel filter surface by the fuel sloshing within the tank when the vehicle is in motion or other activity is used to promote a relative motion of the fuel and filter.

Additionally, a coating that repels water and is attracted to organic molecules such as hydrocarbon fuel or fat will reduce the chance of water finding a nucleation site on the surface of the filter and thereby promote water ice from freezing on the filter media and thereby plugging the filtration media. When the coating is applied to the surface of the filter mesh, it may also have additional benefits of smoothing any imperfections on the surface of the filter media and even filling in crevices between adjoining elements of the filter media such that nucleation sites whereby hydrocarbon fuel crystals will form at sufficiently low temperatures. Suppressing the crystallization temperature of fuel near the filter site will have a benefit of allowing liquid fuel to flow through the filter before the filter is plugged with solid or semi-solid hydrocarbon crystals.

An alternative to coating of the filter media in order to reduce water droplets from passing through the filter media and to suppress the tendency of water and or fuel from crystalizing near the filter is to make the filter media out of a material that has hydrophobic properties such as Teflon or to process, clean or arrange the surface of filtration media such that it has a low surface energy, lower wettability and low nucleation potential or microscopic surface defects. In some exemplary embodiments, the fuel filter assembly projects outside of the guide tube such that the end portion of the filter assembly mesh is in direct contact with fuel within the fuel tank. As such the action of fuel sloshing past the filter can be used to dislodge contaminants from the surface of the filter mesh while the truck is in motion. This action therefore promotes a cleaning action to the end of the filter most likely to accumulate contamination and particulate matter. In one exemplary embodiment, a first coating can be applied to the fuel element 20. The surface coating can promote adhesion of nonpolar fuel molecules and repel the polar molecules of water.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A fuel filter apparatus, comprising:
a filter element assembly having a first end and a second, wherein the filter element assembly comprises:
a filter element having an interior surface and an exterior surface, wherein an interior passage runs through the length of the filter element, wherein fuel can pass through the filter element from the exterior surface through interior surface and into the interior passage of the fuel element, and
a filter element holder having an interior portion configured to house the filter element;
a fuel tube having a first end and a second end, wherein the fuel tube can run through the passage of the filter element, wherein the fuel tube is fluidly connected to the interior passage of the filter element;
a fuel line holder having a first end and a second end, wherein the fuel line holder is removably coupled to the filter element assembly, wherein the fuel line holder; and
a fuel tube for transporting filtered fuel from the interior passage of the filter element.

2. The apparatus of claim 1, further comprising a filter guide tube.

3. The apparatus of claim 2, wherein the filter element comprises a first end and a second end, wherein the first end has a first conductive ring and the second end has a second conductive ring, wherein each conductive ring approximates an entire edge of the filter element.

4. The apparatus of claim 3, wherein the first conductive ring is communicatively coupled to an electrical source having a first polarity, and wherein the second conductive ring is communicatively coupled to the electrical source having a second polarity.

5. The apparatus of claim 4, wherein the energy may be applied to the first ring and second ring and through the filter to generate heat to prevent fuel crystals from accumulating on the filter mesh.

6. The apparatus of claim 5, wherein the filter element holder is injected molded around the filter element.

7. The apparatus of claim 4, wherein filter element is comprised of a conductive material, wherein the first conductive ring, the conductive filter element, and the second conductive ring are communicatively coupled to an energy source to supply a current to heat the filter element to prevent fuel crystallization proximate to the filter element.

8. The apparatus of claim 7, wherein the current provided is a steady flow current.

9. The apparatus of claim 8, wherein the current provided to the filter element is a pulsed current.

10. The apparatus of claim 9, wherein the pulsed current corresponds to an electrical solenoid pump for pumping the flow of fuel through the filter element.

11. The apparatus of claim 9, wherein the filter element is a face packed orientation for holding contamination.

12. The apparatus of claim 7, wherein fuel tube is sealed to the top of the filter assembly to ensure no leakage and the fuel line holder is sealed to the bottom of the filter housing, and the filter element is bonded to the filter housing to prevent the chance of contamination passing through the filter.

13. The apparatus of claim 12, wherein the fuel line holder provides a a positive stop so that the inlet aperture of the fuel tube can be no closer than a pre-determined distance from the bottom of the fuel tank.

14. The apparatus of claim 13, wherein the filter guide tube ensures correct direction, orientation and direction of the fuel filter assembly within a fuel tank.

15. The apparatus of claim 10, wherein the fuel tube is a one-piece construction to the fuel pump inlet to further inhibit leakage and air contamination within the fuel path before the pump.

16. The apparatus of claim 7, wherein the filter element holder is securely coupled to the filter element and inhibits distortion of the filter element within the filter element holder during operation.

17. The apparatus of claim 16, wherein the filter element holder includes at least one passage to allow for fuel to easily flow to the surface of the filter element when the filter assembly is held within the guide tube.

18. The apparatus of claim 17, wherein the exterior surface of the filter element may be cleaned by the action of fuel movement within the tank by normal operation of the vehicle.

19. The apparatus of claim 17, wherein the filter element further comprises a surface coating to promote adhesion of nonpolar fuel molecules and repel the polar molecules of water.

20. A fuel filter comprising:
a filter element having a first end and a second end, wherein the first end has a first conductive ring, and the second end has a second conductive ring, wherein each conductive ring approximates an entire edge of the filter element, wherein the filter element is comprised of a conductive material.
